(19) United States
(12) Patent Application Publication
(10) Pub. No.: US 2007/0121425 A1
(43) Pub. Date: May 31, 2007

(54) Time zone identifier

(76) Inventors: Markus Eble, Walldorf (DE); Gundula Niemann, Wiesloch (DE); Bernhard Schilling, Heidelberg (DE)

Correspondence Address: FISH & RICHARDSON, P.C., PO BOX 1022, MINNEAPOLIS, MN, 55440-1022, US

(21) Appl. No.: 11/291,245

(22) Filed: Nov. 30, 2005

(51) Int. Cl. G04B 19/22

(52) U.S. Cl. 368/21

(57) ABSTRACT

A time zone identifier for a geographic location is generated by receiving a request, including a first information portion in the time zone identifier that represents a time difference between a standard time and a local base time for the geographic location, and, if there exists a rule specifying when the geographic location observes daylight saving time, including a second information portion identifying the rule in the time zone identifier. Otherwise, the second information portion is not included. A computer-readable data structure for a time zone identifier includes a first attribute for the first information portion and a second attribute for the second information portion. A computer system includes a rule repository and a time zone management module.

### TECHNICAL FIELD

The description relates to a time zone identifier for a geographic location.

### BACKGROUND

Nowadays, people and businesses are increasingly engaging in contacts with each other across borders and around the world. Those contacts are also more and more often carried out with some help of computers. Unlike people, a computer engaged in communication typically has little or no notion of whether the computer at the other end is located in the same room or on another continent. It is therefore very important that the computers specify dates and times in a manner that is universal, consistent and free from ambiguities.

At a simplistic level, the Earth may be considered as divided into 24 hour zones, often called time zones. These zones are refined due to regional needs like state borders, which yields a collection of geographic base time zones characterized by their time offset to the Coordinated Universal Time, commonly referred to as the UTC.

Further information is needed to determine the exact local time, such as the rule for observance of daylight saving time. Thus the common regional time zones were created.

However, the existing time zones have ambiguities in their names, and references to daylight saving time are not very clear. They also do not account for all aspects of time at the local level. For example, portions of the United States are in a time zone referred to as Central Standard Time (CST). However, the CST name also is used to denote local times in China, Australia and Cuba, which can lead to mistakes or confusion. Also, many, but not all, regions of the world observe daylight saving time during a portion of the year. However, the rules for daylight saving are not standardized but can vary from region to region, also within a traditional time zone. As a result, a time specified using one of the basic time zones may differ from the local time at a particular location. Also, the common regional time zone names, or a time specified using a common time zone name, may be ambiguous.

### SUMMARY

The invention relates to a time zone identifier.

In a first general aspect, a method of generating a time zone identifier for a geographic location includes receiving a request to generate a time zone identifier for a geographic location. According to the method, a first information portion is included in the time zone identifier that represents a time difference between a standard time and a local base time for the geographic location. According to the method, a second information portion is included in the time zone identifier if there exists a rule specifying when the geographic location observes daylight saving time. The second information portion identifies the rule. Otherwise, according to the method, the second information portion is not included.

Implementations may include any or all of the following features. The first information portion may numerically indicate the time difference. The first information portion may includes a letter indicating whether the time difference is positive or negative. The second information portion may identify the rule by naming an authoritative body that creates the rule. The second information portion may include an extension. The method may further include generating, using the time zone identifier, a time descriptor to be associated with a time stamp relating to the geographical location. When the rule does exist and the time stamp falls within the daylight saving time at the geographical location, the time descriptor may be generated to include the time zone identifier and a daylight saving time indicator. When the rule does exist and the time stamp does not fall within the daylight saving time at the geographical location, the time descriptor may be generated to include the time zone identifier and not to include a daylight saving time indicator.

In a second general aspect, a data structure for a time zone identifier is computer-readable and includes a first attribute configured to contain a first information portion that represents a time difference between a standard time and a local base time for a geographic location. The data structure further includes a second attribute configured to contain a second information portion identifying a rule specifying when the geographic location observes daylight saving time. The second attribute is to be empty if the rule does not exist.

Implementations may include any or all of the following features. The first information portion may numerically indicate the time difference. The first information portion may include a letter indicating whether the time difference is positive or negative. The second information portion may identify the rule by naming an authoritative body that creates the rule. The second information portion may include an extension. The data structure may be included in a time descriptor to be associated with a time stamp relating to the geographical location. The time descriptor may include a third attribute configured to contain a third information portion indicating that the time stamp falls within the daylight saving time at the geographical location.

In a third general aspect, a computer system includes a repository including rules associated with at least some of several geographic locations. Each rule specifies for at least one of the several geographic locations when the geographic location observes daylight saving time. The computer system further includes a time zone management module managing time zone identifiers for the several geographic locations. Each of the time zone identifiers includes a first information portion representing a time difference between a standard time and a local base time. The time zone identifiers are configured to further include a second information portion identifying one of the rules such that the rule can be accessed in the repository. Absence of the second information portion from any of the time zone identifiers indicates that the rule does not exist.

Implementations may include any or all of the following features. The time zone management module may evaluate a length of a time interval relating to the geographical location, the time interval being defined using a time stamp. The time zone management module may performs a conversion of a time descriptor that is based on one of the time zone identifiers. If the time descriptor includes only the first information portion and does not comprise the second information portion, the time zone management module may perform the conversion using the time difference indicated by the first information portion. If the time descriptor includes the first information portion and the second information portion, and does not also include a daylight saving time indicator, the time zone management module may perform the conversion using the time difference indicated by the first information portion. If the time descriptor includes the first information portion and the second information portion, and also includes a daylight saving time indicator, the time zone management module accesses one of the rules in the repository to determine the daylight saving time, the rule being identified using the second information portion.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is an example of a data structure for a time zone identifier associated with a geographical location.

FIG. 1B is an example of data structure for a time stamp that includes a time descriptor.

FIG. 2 is a block diagram of an exemplary computer system that uses time zone identifiers or time descriptors.

FIG. 3 is a flow chart of a method that may be performed to generate a time zone identifier or a time descriptor.

FIG. 4 is a block diagram of a computer system.

Like reference numerals in the various drawings indicate like elements.

### DETAILED DESCRIPTION

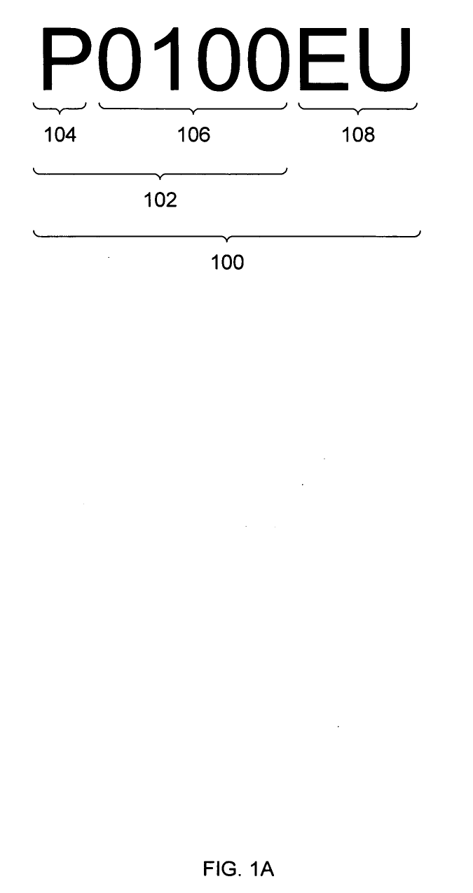

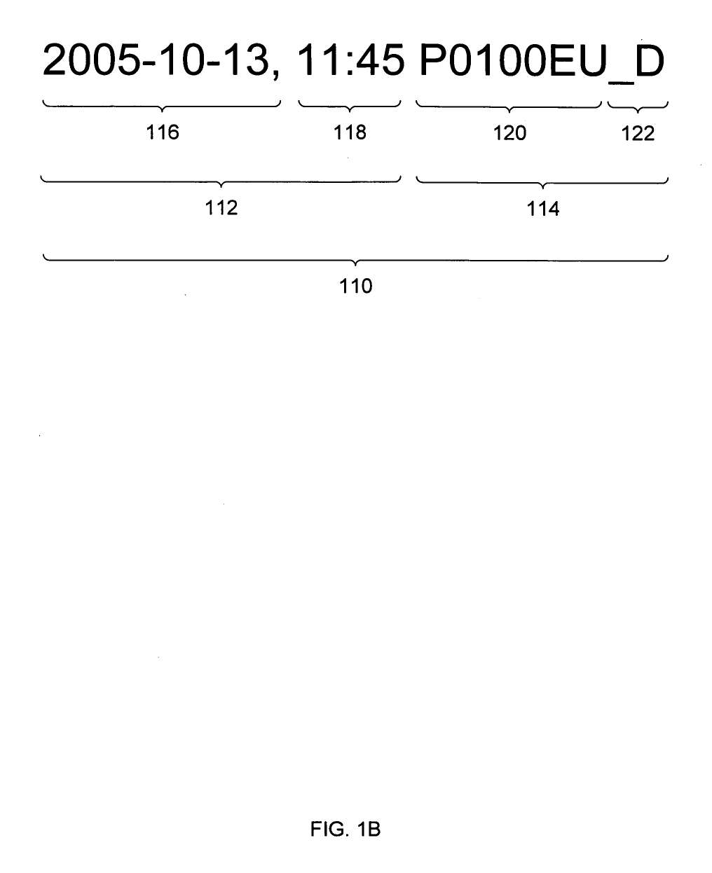

FIG. 1A is an example of a time zone identifier 100. The time zone identifier 100 identifies a local base time for a particular geographic location, in this example Germany, relative to a standard time. Germany is one hour ahead of the UTC. The origin for the UTC is the Zero Meridian going through Greenwich, England. The time difference between the local time used in Germany and the UTC is positive and the amount is one hour. The time zone identifier 100 reflects these circumstances and also contains an identifier for the rule that governs Germany's observance of daylight saving time. That is, the identified rule specifies when the geographic location observes daylight saving time.

Here, the time zone identifier 100 includes a first attribute 102 that indicates the magnitude of the time difference between the standard time and the local base time, and whether it is positive or negative. The first attribute 102 includes a first portion 104 that here contains a “P” for plus, indicating a positive difference. A second portion 106 of the first attribute 102 here contains “0100” for one hour, representing the number of hours and minutes that the local base time differs from the UTC, or any other standard time used as a reference. Similarly, time zones that are behind the UTC, or any other standard time, are marked with an “M” for minus. The information of the first attribute 102 may be considered a geographical time zone identifier. In other implementations, the first information portion can be a code, such as the letter A or B, that represents the local base time.

The data structure for Germany's time zone can include the first attribute 102 and also a second attribute 108. The second attribute 108 contains an identifier for the daylight saving time rule. For example, the second attribute 108 identifies the rule using a regional code. The daylight saving time rule is defined by law or other authoritative decision in each country or region and can change on a yearly basis. Daylight saving time rules, identified by their regional codes, can be formulated into computer readable form and stored in a repository. The information stored in the second attribute 108 can be used to access the correct rule within the repository. This can be useful for determining when a particular location (or region) will change to or from daylight saving time because that will affect timestamps and other measurements of time. The local base time for the geographic region remains unchanged both when the geographic region observes daylight saving time and when it does not.

The rules for daylight saving time will likely be different in many countries or regions. For example, the current rule applying to European countries (denoted by the regional code “EU” in this example) is that daylight saving time begins on the last Sunday in March at 01:00 UTC and ends on the last Sunday in October at 01:00 UTC. Table 1 below lists examples of daylight saving time rules for many regions of the world. Each rule is characterized by the times at which daylight saving time starts and ends, respectively. The rules are identified using regional codes such as EU, US and so on. Thus, given the name of a particular region, Table 1 can provide the regional code that is associated therewith. As another example, given a particular regional code, Table 1 can provide the starting or ending time for daylight saving.

Table 2 below lists examples of time zone identifiers. The entries in Table 2 illustrate time zone identifiers for specific regions. These regions may consist of a country, a state within a country or another regional authority. For example, as is shown in Table 2, the state of Colorado in the United States follows the daylight saving rule of the United States. This is specified by assigning the “US” regional code to the second attribute 108 of the time zone identifier 100. For Colorado, time zone identifier 100 is “M0700US” where the “M” indicates a negative difference from the UTC. The number “0700” represents the number of hours and minutes that the local time differs from the UTC.

As another example, the state of Arizona is located in the same time zone as the state of Colorado and does not observe daylight saving time. Arizona's time zone identifier therefore reads “M0700” where the second attribute 108 of the time zone identifier 100 is empty. However, the Navajo Reservation is a local authority within the state of Arizona and observes daylight saving time according to the daylight saving rule of the United States. Therefore, as is shown in Table 2, the Navajo Reservation has a time zone identifier of “M0700US”, the same as the state of Colorado as described above. Within the Navajo Reservation, however, lies the Hopi Reservation that does not observe daylight saving time. Therefore, the time zone identifier for the Hopi Reservation is “M0700”, the same as the state of Arizona.

The information portions that identify respective rules for daylight saving may be provided with one or more extensions. If, for example, the Navajo Reservation were to adopt a daylight saving time rule different from the US rule, the time zone indicator could be modified to read: M0700US_AZ_NV. Here, the refining information in the extension—US for United States, AZ for Arizona and NV for Navajo—is needed to avoid confusion, because NV represents the state of Nevada within the United States and could in the future be adopted as a state identifier somewhere in the world.

In some implementations, the first portion of the daylight saving time rule identifier is an official abbreviation (ISO Country code) for the authority that reigns the region and that defines a daylight saving time rule. Parts of that region may not follow the reigning authority's rule and other regions, ruled by different authorities, may decide to follow the rule. For example, should the Hopi Reservation decide to use a daylight saving time rule different from the one observed in the US and also different from the one observed in the Navajo reservation, then it may be abbreviated as US_AZ_HP.

Using an extension may have the further advantage of minimizing an error if the specific rule is not known. If the receiving party does not know the extension for some reason, he or she can access the basic rule. For example: Since more than ten years, the German daylight saving time rule (here denoted EU_DE as an extension of the European rule) is equivalent to the EU rule. Differences occurred in the 1980s when no common rule for all EU countries existed. So if the receiving party does not know the EU_DE rule and instead falls back on the EU rule, the time calculation for the last 10 years is still accurate. Thus, the extension may facilitate a lookup mechanism in the rule repository that also has a fallback mechanism.

FIG. 1B is an example of a time stamp 110. The time stamp 110 identifies a specific point in time at a particular geographical location and here reads: 2005-10-13,11:45 P0100EU_D. The time stamp indicates that the specific point in time is Oct. 13, 2005 at 11:45 am, in a region where a local base time is one hour ahead of the UTC. Moreover, the time stamp indicates that the region follows the EU rule for daylight saving time, such as Germany, and that daylight saving time is observed at the specified date and time. The time stamp 110 consists of a date and time portion 112 that includes a first attribute 116 and a second attribute 118. The first attribute 116 contains a calendar date which includes the month, day and year. The second attribute 118 contains a time measured in hours and minutes. In this example, the information portion of the first attribute contains “2005-10-13” representing the calendar day of Oct. 13, 2005 and the information portion of the second attribute is “11:45” representing 11 hours and 45 minutes past midnight.

The time stamp 110 further includes a time descriptor 114 that includes a first attribute 120 and a second attribute 122. The first attribute 120 contains a time zone identifier as shown in FIG. 1A. The second attribute 122 indicates that daylight saving time is in effect at the specified date and time. In this example, the information portion of the second attribute 122 is “_D”. The second attribute may be considered an extension of the time zone identifier.

The following examples illustrate the use of the time stamp 110. First, a teleconference is to be scheduled between two parties, one is located in Walldorf, Germany and the other is located in the city of Denver in the state of Colorado in the United States. The call is to take place on Oct. 13, 2005 at 11:45 am local time in Walldorf, Germany. The time stamp 110 may therefore be sent electronically from a computer in Germany to automatically schedule the meeting. The time stamp 110 indicates that Walldorf, Germany has a positive time difference from the UTC of one hour, as described above. It also indicates that Walldorf, Germany at this specific date and time will be observing daylight saving time. Using Tables 1 and 2, the Colorado computer can determine that the state of Colorado has a time zone identifier 100 indicating a negative time difference from the UTC of seven hours and that Denver, Colorado is also observing daylight saving time. Therefore, using the time zone identifiers for both locations the system can determine the local time in Colorado that the teleconference will occur. The time stamp that the Colorado computer uses for the teleconference time is “2005-10-13, 3:45 M0700US_D”.

Other conversions may be performed. For example, a conversion can be performed from a local time zone to a standard time zone (such as the UTC) for the purpose of storing time stamps. The stored standard time can be converted back into the original local time zone or into a different time zone. Conversions are useful for maintaining time records within computer systems or for displaying correct time stamps to users. This might apply to file time stamps or email sent/received time stamps, to mention a few examples.

Second, time stamps can be used to determine the length of a time interval. A test is begun in Walldorf, Germany with its start point indicated by the time stamp 110 illustrated in FIG. 1B. The test needs to run for 720 hours. Based on the time stamp 110, another time stamp is to be determined for the purpose of ending the test after 720 hours. The extension “_D” of the time stamp 110 indicates that daylight saving time is in effect at the beginning of the 720 hour period. Using the EU code indicator from the time stamp 110, the system determines that the EU rule for daylight saving applies to this geographical region, and that according to that rule daylight saving ends on the last Sunday in October. Thus, the end of daylight saving falls within the time interval (720 hours), and therefore affects the other time stamp that marks the end of the interval. The system takes the end of daylight saving into account when generating the end time stamp so that the test will run for exactly 720 hours as needed.

The exact length of a time interval can be important in many different situations. One example involves industrial production processes, wherein it may be critical that a stage, such as a baking procedure or a cooling period, is implemented with great precision.

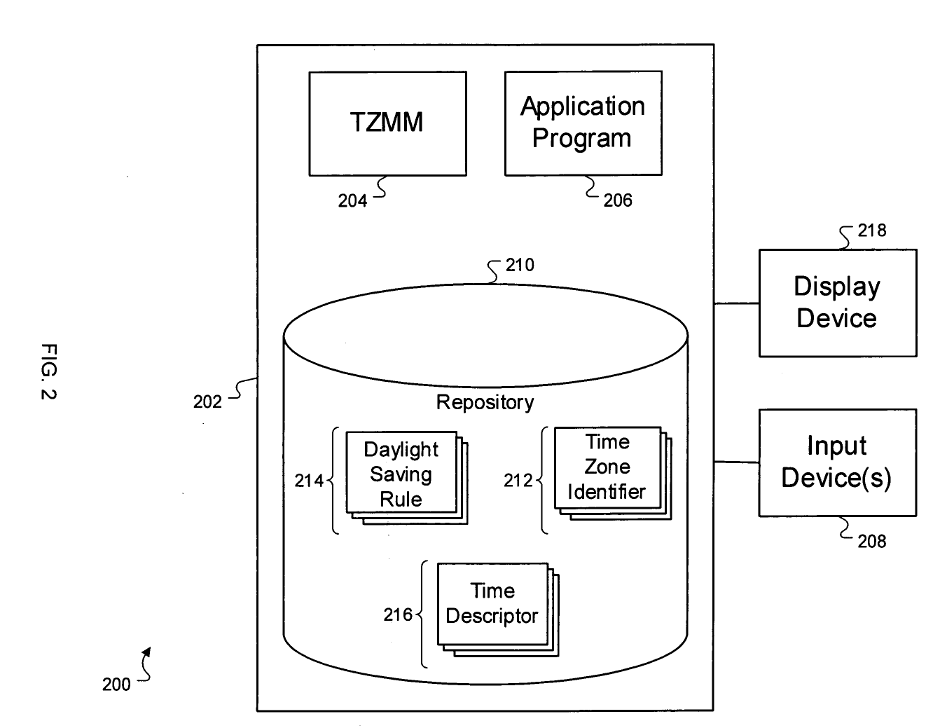

FIG. 2 is a block diagram of an exemplary computer system 200 that uses time descriptors or time zone identifiers. Here, the system includes a computer device 202 that contains a time zone management module (TZMM) 204. The TZMM 204 manages the generation and use of time zone identifiers and time descriptors. An application program 206 may be used for different purposes in the system and receives user inputs through input device(s) 208. The repository includes time zone identifier records 212 that are data structures in form of the time zone identifier 100. The time zone identifier records 212 may contain the information shown in Table 2. The repository includes daylight saving rule records 214 that may be accessed using the regional code contained in the second attribute 108 of the time zone identifier 100. The daylight saving rule records 214 may contain the information shown in Table 1. The repository includes time descriptor records 216 that may contain information having a data structure as described above with regard to FIG. 1B. Any or all of the records 212, 214 and 216 may be implemented using tables in a database.

Here, the application program 206 performs an operation that involves specifying a local time at a particular geographic location, either where the computer device 202 is situated or at a remote location. The application program 206 sends a request to the TZMM 204 to generate a time stamp. The TZMM 204 uses the information in the repository in doing so. The TZMM may access the time zone identifier records 212, the daylight saving rule records 214 and the time descriptor records 216.

For example, a user working with the input device(s) 208 makes an input that requires the system to register a local date and time. The computer system 200 has knowledge of the user's geographical location, in this example, Walldorf, Germany. Moreover, the date at issue is 2005-10-13 and the time is 11:45 am. The application program 206 sends a request to the TZMM 204 to generate a time stamp for this date and time.

The TZMM 204 accesses the repository 210 in fulfilling the request. From the time zone identifier records 212 the TZMM 204 obtains the time zone identifier “P0100EU” for Germany. The TZMM 204 then determines if the geographical location observes daylight saving time by examining the second attribute 108 of the time zone identifier 100. In this example, the information is the regional code “EU”, indicating that this geographical location observes daylight saving time according to the EU rule.

Upon determining that, under the EU rule, daylight saving is observed on the date and time at issue, the TZMM 204 sets the information portion of the second attribute 122 of the time descriptor 114 to “_D”. The completed time descriptor in this example thus reads “P0100EU_D”. Alternately, the time descriptor may be obtained from the time descriptor records 216 as a predefined time descriptor. The TZMM 204 concatenates the time descriptor with the information representing the time and date at issue (such as the date and time portion 112) and forwards the time stamp to the application program 206, perhaps for presentation on the display device 218, or performs another predefined action on it, such as storing it. To name just one example, the retrieved information can be used to transform a local time into a standard time (such as the UTC) for a (universal) time stamp, and to convert the time stamp back into local time, for example for displaying it.

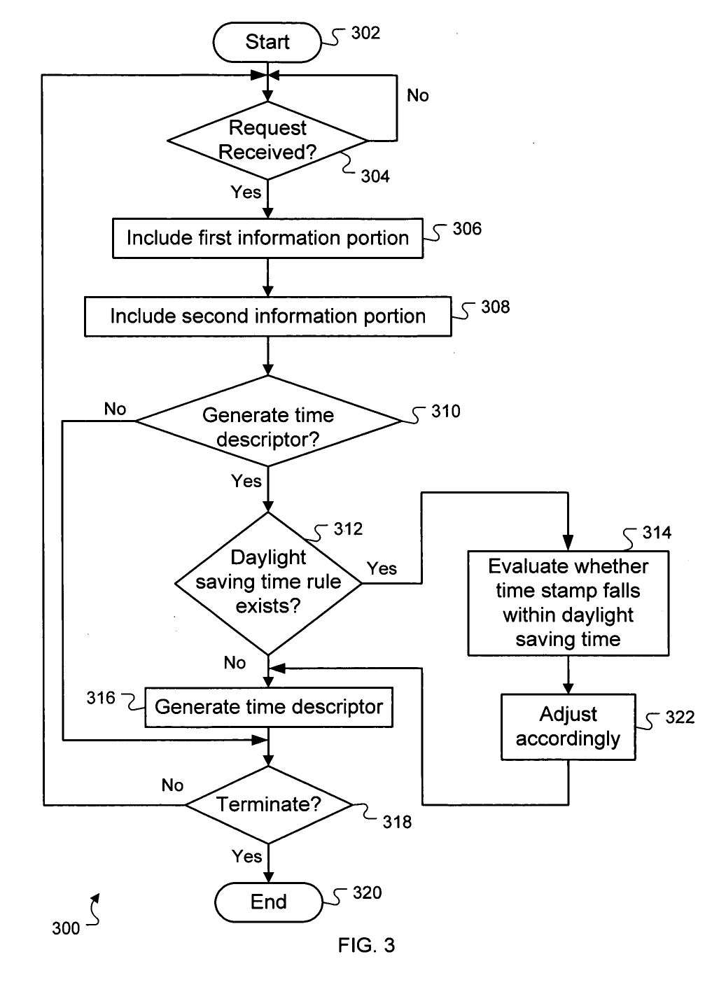

FIG. 3 is a flow chart of exemplary operations 300 that can be performed to generate a time zone identifier or a time descriptor. A processor executing instructions stored in a computer program product can perform the operations 300. The operations 300 start at a start step 302. This can occur when the computer system 200 is running and an operator initiates a particular function of the application program 206. The operations include a step 304 which waits to receive a request to generate a time zone identifier or time descriptor for a geographic location.

Upon a request being received, the operations 300 proceed to a step 306 in which a first information portion is included in the time zone identifier. The first information portion numerically indicates a time difference between a standard time and a local time at the geographic location for which the time zone identifier is being generated. For example, the TZMM 204 can include the information “P0100” in the first attribute 102 of the time zone identifier 100. The operations also include a step 308 in which a second information portion may be included in the time zone identifier. The second information portion is included if a rule specifying when the geographical location observes daylight saving time exists. In such cases, there is included an information portion that identifies the rule. For example, the TZMM 204 can include the information “EU” in the second attribute 108 of the time zone identifier 100. If the rule does not exist, the second information portion is left empty.

Next included in the operations 300 is a step 310 that decides whether or not a time descriptor should be generated. This may be determined based on the request that the TZMM 204 receives. If the decision at step 310 is yes, the operations 300 proceed to step 312. In step 312, it is determined whether there exists a rule for observance of daylight saving at the geographic location. This may be done by the TZMM 204 examining the second information portion 108 of the time zone identifier 100. If the rule exists, the operations 300 proceed to step 314.

In step 314 it is evaluated whether the date and time to which the time descriptor relates falls within the daylight saving time observation period. This may be determined by the TZMM 204 evaluating the applicable rule in the daylight saving rule records 214. If the date and time fall within daylight saving time, the time descriptor is adjusted accordingly in step 322. For example, an extension “_D” may be added at the end. If the date and time do not fall within daylight saving time, the step 322 may be omitted and the time descriptor may be used as is.

The time descriptor is generated in step 316. This may involve the TZMM 204 forwarding the time descriptor to the application program 206 or storing it in a repository 210. The generated time descriptor may be included in a time stamp 110. The operations 300 also proceed to step 316 if a daylight saving rule does not exist in step 312.

The operations next include step 318 where it is decided if the operations 300 should terminate and go to the end step 320 or continue and return to step 304 to wait for another request to generate a time zone identifier or time descriptor for a geographic location. The operations also perform step 318 if it is determined in step 310 that no time descriptor is to be generated. The operations for generating a time descriptor may also be performed independently from the operations for generating a time zone identifier, such as when the time zone identifiers have been predefined.

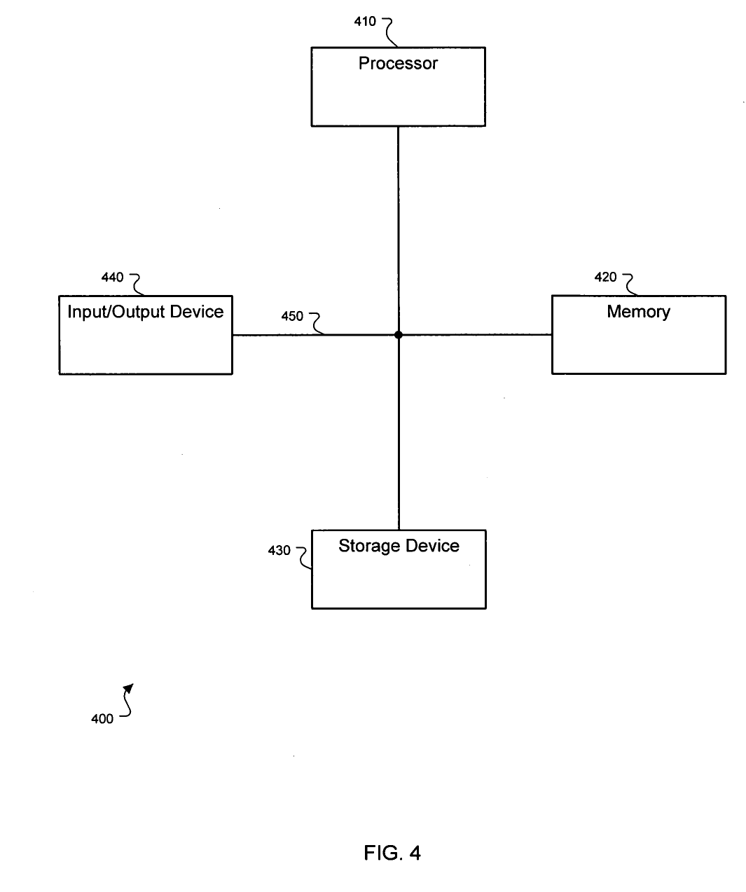

FIG. 4 is a block diagram of a computer system 400 that can be used in the operations described above, according to one embodiment. For example, the system 400 may be included in the computer system 200.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one embodiment, the processor 410 is a single-threaded processor. In another embodiment, the processor 410 is a multi-threaded processor. The processor 410 is capable of processing instructions stored in the memory 420 or on the storage device 430 to display graphical information for a user interface on the input/output device 440.

The memory 420 stores information within the system 400. In one embodiment, the memory 420 is a computer-readable medium. In one embodiment, the memory 420 is a volatile memory unit. In another embodiment, the memory 420 is a non-volatile memory unit.

The storage device 430 is capable of providing mass storage for the system 400. In one embodiment, the storage device 430 is a computer-readable medium. In various different embodiments, the storage device 430 may be a floppy disk device, a hard disk device, an optical disk device, or a tape device.

The input/output device 440 provides input/output operations for the system 400. In one embodiment, the input/output device 440 includes a keyboard and/or pointing device. In one embodiment, the input/output device 440 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard, a pointing device such as a mouse, a trackball or a microphone and a speech-recognition program, or any other input device by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

TABLE 1

| DST | Used in Country/ | Start of DST | End of DST |
|---|---|---|---|
| Rule | Region in 2005 | rule in 2005 | rule in 2005 |
| EU | Albania | Last Sunday in | Last Sunday in |
| | Andorra | March, at 01:00 | October, at |
| | Armenia | UTC | 01:00 UTC |
| | Austria | | |
| | Azerbaijan | | |
| | Belarus | | |
| | Belgium | | |
| | Bosnia and | | |
| | Herzogowina | | |
| | Bulgaria | | |
| | Croatia | | |
| | Cyprus | | |
| | Czech Republic | | |
| | Denmark | | |
| | Denmark - | | |
| | Faroe Islands | | |
| | Estonia | | |
| | Finland | | |
| | France | | |
| | Georgia | | |
| | Germany | | |
| | Greece | | |
| | Hungary | | |
| | Ireland | | |
| | Italy | | |
| | Latvia | | |
| | Lebanon | | |
| | Liechtenstein | | |
| | Lithuania | | |
| | Louxembourg | | |
| | Macedonia | | |
| | Malta | | |
| | Moldova | | |
| | Monaco | | |
| | Montenegro | | |
| | Netherlands | | |
| | Norway | | |
| | Poland | | |
| | Portugal | | |
| | Portugal - Madeira | | |
| | Portugal - Azores | | |
| | Romania | | |
| | Russia | | |
| | San Marino | | |
| | Serbia | | |
| | Slovak Republick | | |
| | Slovenia | | |
| | Spain | | |
| | Spain - | | |
| | Canary Islands | | |
| | Sweden | | |
| | Switzerland | | |
| | Turkey | | |
| | U.K. - England | | |
| | U.K. - Gibraltar | | |
| | U.K. - Northern | | |
| | Ireland | | |
| | U.K. - Scotland | | |
| | U.K. - Wales | | |
| | Ukraine | | |
| | Vatican City | | |
| US | Bahamas | First Sunday | Last Sunday in |
| | Canada (except | in April, at | October, at |
| | Saskatchevan) | 02:00 local time | 02:00 local |
| | Haiti | | daylight saving |
| | Mexico | | time |
| | Saint Pierre and | | |
| | Miquelon | | |
| | Turks and Caicos | | |
| | Islands | | |
| | U.K. - Bermuda | | |
| | USA (except Hawaii, | | |
| | Arizona, part of | | |
| | Indiana) | | |
| CU | Cuba | 1st of April, at | Last Sunday in |
| | | 01:00 local time | October, at |
| | | | 01:00 local |
| | | | daylight saving |
| | | | time |
| EU_GR | Denmark - Greenland | Saturday before | Saturday before |
| | | last Sunday in | last Sunday in |
| | | March, at 01:00 | October, at |
| | | UTC | 01:00 UTC |
| EG | Egypt | Last Friday | Last Friday in |
| | | in April, at | September, at |
| | | 0:00 local time | 0:00 local |
| | | | daylight saving |
| | | | time |
| IL_GA | Gaza Strip | First Friday | First Friday on |
| | | on or after | or after 15 |
| | | 15 April, at | October, at |
| | | 0:00 local time | 02:00 local |
| | | | daylight saving |
| | | | time |
| IR | Iran | the first day | the first day |
| | | of Farvardin, at | of Mehr, at |
| | | 0:00 local time | 0:00 local |
| | | | daylight saving |
| | | | time |
| IQ | Iraq | 1st of April, at | 1st of October, |
| | | 03:00 local time | at 04:00 local |
| | | | daylight saving |
| | | | time |
| IL | Israel | 1st of April, at | The Saturday |
| | | 02:00 local time | between Rosh |
| | | | Hashana and |
| | | | Yom Kippur, at |
| | | | 02:00 local |
| | | | daylight saving |
| | | | time |
| JO | Jordan | Last Thursday | Last Thursday |
| | | in March, at | in March, at |
| | | 0:00 local time | 01:00 local |
| | | | daylight saving |
| | | | time |
| SY | Syria | 1st of April, at | 30st of October, |
| | | 0:00 local time | at 0:00 local |
| | | | daylight saving |
| | | | time |
| AUS | Australia - Lord | Last Sunday | Last Sunday in |
| | Howe Island | in October, at | March, at 03:00 |
| | Australia - New | 02:00 local time | local daylight |
| | South Wales | | saving time |
| | Australia - South | | |
| | Australia | | |
| | Australia - Victoria | | |
| AUS_TA | Australia - Tasmania | First Sunday | Last Sunday in |
| | | in October, at | March, at 03:00 |
| | | 02:00 local time | local daylight |
| | | | saving time |
| BR | Brazil (part) | First Sunday | Third Sunday in |
| | | in November, at | February, at |
| | | 0:00 local time | 0:00 local |
| | | | daylight saving |
| | | | time |
| CL | Chile | Second Saturday | Second Saturday |
| | Chile - Easter | of October - at | of March - at |
| | Island | midnight local | midnight local |
| | Antarctica - Palmer | time | daylight saving |
| | Station (USA) | | time |
| | Antarctica - | | |
| | O'Higgins Station | | |
| | (Chile) | | |
| NA | Namibia | First Sunday | First Sunday |
| | | in September, at | in April, at |
| | | 02:00 local time | 02:00 local |
| | | | daylight |
| | | | saving time |
| NZ | New Zealand | First Sunday | Third Sunday |
| | New Zealand - | in October, at | in March, at |
| | Chatham Island | 02:00 local | 02:00 local |
| | Antarctica - | daylight saving | daylight |
| | Amundsen-Scott | time | saving time |
| | (South Pole) | | |
| | Antarctica - McMurdo | | |
| | Station (USA) | | |
| | Antarctica - Scott | | |
| | Station (N.Z.) | | |
| PY | Paraguay | First Sunday | First Sunday |
| | | in September, at | in April, at |
| | | 0:00 local time | 0:00 local |
| | | | daylight |
| | | | saving time |
| GB_FA | U.K. Falkland | First Sunday | First Sunday |
| | Islands (Malvinas) | on or after 8 | on or after 6 |
| | | September, at | April, at 02:00 |
| | | 02:00 local time | local daylight |
| | | | saving time |

TABLE 2

| | | | Tradi- |
|---|---|---|---|
| | Time Zone | | tional |
| Country | Identifier | Remark | Name |
| Ireland | P0000EU | (geo base time zone UTC, | GMT, |
| | | European daylight saving | WET, |
| | | time) | in |
| | | | summer |
| | | | IST |
| Germany | P0100EU | (geo base time zone UTC + | CET, |
| | | 1, European daylight | MET |
| | | saving time rule) | |
| Israel | P0200IL | (geo base time zone UTC + | IST |
| | | 2, Israelian daylight | |
| | | saving time) | |
| India | P0530 | (geo base time zone UTC + | IST |
| | | 5:30, no daylight saving | |
| | | time) | |
| China | P0800 | (geo base time zone UTC + | CST |
| | | 8:00, no daylight saving | |
| | | time) | |
| Australia - | P0930AU | (geo base time zone UTC + | CAST, |
| New South | | 9:30, Australian daylight | CST |
| Wales | | saving time rule) | |
| Australia - | P1130 | (geo base time zone UTC + | NFT |
| Norfolk | | 11:30, no daylight saving | |
| Island | | time rule) | |
| New Zealand - | P1245NZ | (geo base time zone UTC + | CHAST |
| Chatham | | 12:45, New Zealandian | |
| Island | | daylight saving time rule) | |
| Baker | M1200 | (geo base time zone UTC − | IDLW |
| Island | | 12:00, no daylight saving | |
| | | time) | |
| United | M0700US | (geo base time zone UTC − | MST |
| States - | | 7:00, United States rule | |
| Colorado | | for daylight saving time) | |
| United | M0700 | (geo base time zone UTC − | MST |
| States - | | 7:00, no daylight saving | |
| Arizona | | time) | |
| United | M0700US | (geo base time zone UTC + | MST |
| States - | | 7:00, daylight saving | |
| Arizona - | | time rule of the US) in | |
| Navajo | | case the Navajo | |
| Reservation | | reservation changes its | |
| | | daylight saving time rule | |
| | | from following US to | |
| | | something else, | |
| | | M0700US_AZ_NV would be | |
| | | introduced | |
| United | M0600US | (geo base time zone UTC − | CST |
| States - | | 6:00, United States rule | |
| Alabama | | for daylight saving time) | |
| Cuba | M0500CU | (geo base time zone UTC − | AST, |
| | | 5:00, Cuba daylight | in |
| | | saving time rule) | summer |
| | | | CST |
| Canada, New | M0330CA | (geo base time zone UTC − | NFT, |
| Foundland | | 3:30, Canadian daylight | NST |
| | | saving time rule) | |
| Greenland | M0100GL | (geo base time zone UTC − | EGT |
| (east) | | 1:00, Greenlandian | |
| | | daylight saving time rule) | |

What is claimed is:

1. A method of generating a time zone identifier for a geographic location, the method comprising:
receiving a request to generate a time zone identifier for a geographic location;
including a first information portion in the time zone identifier that represents a time difference between a standard time and a local base time for the geographic location; and
including a second information portion in the time zone identifier if there exists a rule specifying when the geographic location observes daylight saving time, the second information portion identifying the rule, otherwise not including the second information portion.

2. The method of claim 1, wherein the first information portion numerically indicates the time difference.

3. The method of claim 1, wherein the first information portion includes a letter indicating whether the time difference is positive or negative.

4. The method of claim 1, wherein the second information portion identifies the rule by naming an authoritative body that creates the rule.

5. The method of claim 1, wherein the second information portion comprises an extension.

6. The method of claim 1, further comprising generating, using the time zone identifier, a time descriptor to be associated with a time stamp relating to the geographical location.

7. The method of claim 6, wherein the rule does exist and wherein the time stamp falls within the daylight saving time at the geographical location, and wherein the time descriptor is generated to include the time zone identifier and a daylight saving time indicator.

8. The method of claim 6, wherein the rule does exist and wherein the time stamp does not fall within the daylight saving time at the geographical location, and wherein the time descriptor is generated to include the time zone identifier and not to include a daylight saving time indicator.

9. The method of claim 6, wherein the time zone identifier does not include the second information portion, and wherein the time descriptor is generated to include only the time zone identifier.

10. A data structure for a time zone identifier, the data structure being computer-readable and comprising:
a first attribute configured to contain a first information portion that represents a time difference between a standard time and a local base time for a geographic location; and
a second attribute configured to contain a second information portion identifying a rule specifying when the geographic location observes daylight saving time, wherein the second attribute is to be empty if the rule does not exist.

11. The data structure of claim 10, wherein the first information portion numerically indicates the time difference.

12. The data structure of claim 10, wherein the first information portion includes a letter indicating whether the time difference is positive or negative.

13. The data structure of claim 10, wherein the second information portion identifies the rule by naming an authoritative body that creates the rule.

14. The data structure of claim 10, wherein the second information portion comprises an extension.

15. The data structure of claim 10 included in a time descriptor to be associated with a time stamp relating to the geographical location.

16. The data structure of claim 15, wherein the time descriptor comprises a third attribute configured to contain a third information portion indicating that the time stamp falls within the daylight saving time at the geographical location.

17. A computer system comprising:
a repository including rules associated with at least some of several geographic locations, each rule specifying for at least one of the several geographic locations when the geographic location observes daylight saving time; and
a time zone management module managing time zone identifiers for the several geographic locations, each of the time zone identifiers including a first information portion representing a time difference between a standard time and a local base time, the time zone identifiers being configured to further include a second information portion identifying one of the rules such that the rule can be accessed in the repository, wherein absence of the second information portion from any of the time zone identifiers indicates that the rule does not exist.

18. The computer system of claim 17, wherein the time zone management module evaluates a length of a time interval relating to the geographical location, the time interval being defined using a time stamp.

19. The computer system of claim 17, wherein the time zone management module performs a conversion of a time descriptor that is based on one of the time zone identifiers.

20. The computer system of claim 19, wherein if the time descriptor comprises only the first information portion and does not comprise the second information portion, the time zone management module performs the conversion using the time difference indicated by the first information portion.

21. The computer system of claim 19, wherein if the time descriptor comprises the first information portion and the second information portion, and does not also include a daylight saving time indicator, the time zone management module performs the conversion using the time difference indicated by the first information portion.

22. The computer system of claim 19, wherein if the time descriptor comprises the first information portion and the second information portion, and also includes a daylight saving time indicator, the time zone management module accesses one of the rules in the repository to determine the daylight saving time, the rule being identified using the second information portion.
